(19) United States
(12) Patent Application Publication
(10) Pub. No.: US 2013/0302705 A1
(43) Pub. Date: Nov. 14, 2013

(54) AIR SECONDARY BATTERY

(71) Applicant: FUJITSU LIMITED, Kawasaki-shi (JP)

(72) Inventors: Kensuke YOSHIDA, Kawasaki (JP); Tsutomu TANAKA, Kawasaki (JP); Tamotsu YAMAMOTO, Kawasaki (JP); Masaaki SASA, Kawasaki (JP)

(73) Assignee: FUJITSU LIMITED, Kawasaki (JP)

(21) Appl. No.: 13/945,146

(22) Filed: Jul. 18, 2013

Related U.S. Application Data
(63) Continuation of application No. PCT/JP2011/053196, filed on Feb. 16, 2011.

(51) Int. Cl. H01M 12/08

(52) U.S. Cl. CPC H01M 12/08
USPC 429/405

(57) ABSTRACT

To provide an air secondary battery, which contains: an anion exchange membrane; an anode containing a metal, which is provided at one side of the anion exchange membrane; and a cathode, which is provided at the opposite side of the anode across the anion exchange membrane, and is in contact with air, wherein the cathode contains an amphoteric catalyst layer containing an amphoteric catalyst, and an oxygen reduction catalyst layer containing an oxygen reduction catalyst in this order from the side of the anion exchange membrane, where the amphoteric catalyst exhibits activity in oxygen reduction, and activity in oxygen generation, and the oxygen reduction catalyst exhibits activity in oxygen reduction.

### CROSS-REFERENCE TO RELATED APPLICATIONS

This application is a continuation application of International Application PCT/JP2011/053196 filed on Feb. 16, 2011 and designated the U.S., the entire contents of which are incorporated herein by reference.

### FIELD

The embodiments discussed herein relate to an alkali metal-air secondary battery, which discharges and charges using oxygen in the air, and a metal built in the battery, and uses an anion exchange membrane as a solid electrolyte.

### BACKGROUND

In order to give countermeasures for the exhaustion of fossil energy sources that would happen in the future, and to reduce discharge of greenhouse gas derived from fossil energy, for example, generation of regenerated energy, such as solar batteries, and wind power generation, and introduction of electric cars have been actively conducted. To further proceed with the introduction and use thereof, it is the most important task to develop technology for accumulating electricity realizing to absorb output variation unique to the generation of regenerated energy, or to give an innovative performance capable of extending a cruising range of an electric car to the level of a gasoline-powered car.

A metal-air secondary battery has attracted an attention as one of such innovative technologies for accumulating electricity. The metal air secondary battery can increase the energy density due to the structure thereof, because oxygen contained in the air acts as a cathode active material to react on a cathode catalyst, and therefore, an active material contained inside the battery is only anode. Accordingly, a larger amount of the anode active material can be contained in the battery, as no cathode active material is contained therein.

As a candidate for the metal-air air secondary battery, there is an alkali metal-air secondary battery using a metal Zn as an anode active material, and an alkali electrolytic solution as an electrolytic solution. This metal-air secondary battery uses the Zn powder mixed with the alkali electrolytic solution (KOH aqueous solution) containing OH⁻ for the anode, and a catalyst capable of reducing and generating oxygen for the cathode (air electrode), and therefore discharge and charge of the metal-air secondary battery can be performed through a battery reaction represented below.

Anode: Zn+2OH⁻ [symbol] ZnO+H₂O+2e⁻

Cathode: ½O₂+H₂O+2e⁻ [symbol] 2OH⁻

Entire reaction: Zn+½O₂ [symbol] ZnO

As for such alkali metal-air secondary battery, a battery system, using an anion exchange membrane, which is an OH⁻ conductive solid polymer electrolyte, has been attracted attention for reducing an amount of a catalyst for use using a thinner layer of a catalyst layer, and securing resistance of a battery to liquid leakage.

The theoretical energy density of the metal Zn as an anode for a battery is 1,350 Wh/kg, and a metal-air secondary battery using the metal Zn is considered to enable to realize a battery having the energy density exceeding 250 Wh/kg, which is considered as a limit for a lithium ion secondary battery. Moreover, Zn, which is an anode, can be stably used with an alkali electrolytic solution, and a non-noble metal, and a non-carbon material can be used for a cathode catalyst layer and a constituting member of the battery, which is advantageous in reduction in cost for constituting members for the battery.

As a battery system using the cathode catalyst layer, and Zn anode, an air-zinc primary battery using an alkali electrolytic solution, which cannot be charged, has been already used on practice, but an air secondary battery, which can perform discharging and charging, has not yet been applied for practical use.

One of the difficulties for realizing practical use of a metal-air secondary battery is a development of a cathode (air electrode) exhibiting excellent activities to both an oxygen reduction reaction and an oxygen generation reaction. As an oxygen reduction catalyst that is a cathode for a discharge reaction, reported are use of platinum that is a catalyst for a fuel battery, and use of MnO₂ that is a catalyst for an air-zinc primary battery. As for an amphoteric catalyst required for a cathode that exhibits activities to both an oxygen reduction reaction, and an oxygen generation reaction required for a charging reaction, for example, proposed are metal oxide (perovskite structure, spinel structure, pyrochlore), and PdNi (see J. Power Sources 165 (2007), 897). However, a cathode material exhibiting sufficient performance for an air secondary battery has not yet been provided.

In the current situation that excellent cathode has not been provided as described above, for example, disclosed is two cells having cathodes corresponding to charging and discharging, respectively, and charging and discharging are performed using the cells by switching the supply from the metal anode (see Japanese Patent Application Laid-Open (JP-A) No. 2006-196329).

However, use of such two-cell structure makes a device complicated, and increases the size thereof. Therefore, it is currently desired to promptly provide an air secondary battery capable of performing discharge and charge with one-cell structure, and equipped with a cathode having excellent battery properties.

### SUMMARY

The disclosed air secondary battery containing:

an anion exchange membrane;

an anode containing a metal, which is provided at one side of the anion exchange membrane; and

a cathode, which is provided at the opposite side of the anode across the anion exchange membrane, and is in contact with air,

wherein the cathode contains an amphoteric catalyst layer containing an amphoteric catalyst, and an oxygen reduction catalyst layer containing an oxygen reduction catalyst in this order from the side of the anion exchange membrane, where the amphoteric catalyst exhibits activity in oxygen reduction, and activity in oxygen generation, and the oxygen reduction catalyst exhibits activity in oxygen reduction.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating one example of the disclosed air secondary battery.

FIG. 2 is a diagram illustrating a reaction model of the air secondary battery at the time of charging.

FIG. 3 is a diagram illustrating a coin cell structure of the air secondary battery used in Examples.

FIG. 4 is a graph depicting discharge-charge cycles of the air secondary batteries of Example 1 and Comparative Examples 1 to 3.

FIG. 5 is a graph depicting discharge outputs of the air secondary batteries of Example 1 and Comparative Example 3 at the time of discharging.

FIG. 6 is a graph depicting discharge-charge cycles of the air secondary batteries of Example 2 and Comparative Example 4.

FIG. 7 is a graph depicting discharge outputs of the air secondary batteries of Example 2 and Comparative Example 4 at the time of discharging.

FIG. 8 is a graph depicting discharge-charge cycles of the air secondary batteries of Example 3 and Comparative Example 5.

FIG. 9 is a graph depicting discharge outputs of the air secondary batteries of Example 3 and Comparative Example 5 at the time of discharging.

### DESCRIPTION OF EMBODIMENTS

The disclosed air secondary battery contains at least an anion exchange membrane, an anode, and a cathode. The air secondary battery preferably contains, for example, a cathode case, an electrolytic solution, an anode case, a spacer, and a gasket as necessity arises, and may further contain other members as necessity arises.

### <Anion Exchange Membrane>

The anion exchange membrane has a function of a solid polymer electrolyte in the air secondary battery, and functions as a base for forming a cathode catalyst layer containing an amphoteric catalyst layer and an oxygen reduction catalyst layer.

The anion exchange membrane (negative ion exchange membrane) is one type of ion exchange membranes. The ion exchange membrane is a resin membrane, which has a principle skeleton containing mainly a fluororesin, and a hydrocarbon-based resin, and is designed to pass through ions having a certain charge by substituting part of these resins with substituent capable of ionization. Moreover, a resin, which has the same structure to that of the aforementioned ion exchange membrane, but is not formed into a membrane, is an ion exchange resin.

As for the ion exchange membrane, there are a cation exchange membrane (positive ion exchange membrane), and an anion exchange membrane.

The cation exchange membrane is an ion exchange membrane, to which mainly a sulfo group (—SO₃H) is introduced as a substituent, and which can pass through only cations due to ionization of proton H⁺ from the sulfo group.

The anion exchange membrane is an ion exchange membrane, to which mainly a quaternary ammonium group (—R₃N⁺A⁻) is introduced, and which can pass through only anions due to ionization of anion A.

As for use of these ion exchange membranes, there are an electrolyte for a fuel cell (cation exchange membrane), and production of pure water (both a cation exchange membrane and an anion exchange membrane are used). As for the anion exchange membrane, NEOSEPTA (Cl⁻ substituted), manufactured by ASTOM Corporation is available as a commercial product for production of pure water.

In order to use such anion exchange membrane as an OH⁻ conductive solid polymer electrolyte of an air secondary battery, it is necessary to substitute anions in substituents with OH⁻, and modify a principle skeleton thereof to secure reliability suitable for use as the air secondary battery, and various material can be used (see JP-A Nos. 2009-173898, and 2000-331693).

The average thickness of the anion exchange membrane is appropriately selected depending on the intended purpose without any limitation, but the average thickness thereof is preferably 10 μm to 100 μm, more preferably 20 μm to 50 μm.

As for the anion exchange membrane, an appropriately synthesized anion exchange membrane may be used, or a commercial product thereof may be used. Examples of the commercial product thereof include anion-conducting electrolyte membrane A series, manufactured by Tokuyama Corporation.

### <Anode>

The anode is an electrode provided at one side of the anion exchange membrane, and containing metal.

The anode is preferably formed of a mixture containing Zn powder, and an alkaline electrolytic solution containing OH⁻.

The anode contains an anode layer containing an anode active material, and an anode current collector configured to collect power of the anode layer. Note that, the below-mentioned anode case may also have a function of an anode current collector.

### —Anode Active Material—

The anode active material is appropriately selected depending on the intended purpose without any limitation, provided that the anode active material is capable of occluding and releasing metal ions. Among them, as metal ions, preferred are alkali metal ions, alkali earth metal ions, Zn ions, Al ions, and Fe ions. Examples of the alkali metal ions include Li ions, Na ions, and K ions. Examples of the alkali earth metal ions include Mg ions, and Ca ions. Among them, Zn ions are particularly preferable.

Examples of the anode active material include simple metal, alloy, metal oxide, and metal nitride.

The anode layer may contain the anode active material alone, or may contain an electroconductive material or a binder resin, or any combination thereof, together with the anode active material. In the case where the anode active material is a foil, for example, the anode active material alone can constitute the anode layer. On the other hand, in the case where the anode active material is powder, the anode layer contains the electroconductive material, or the binder, or any combination thereof, together with the anode active material.

Examples of the electroconductive material include a carbon material. Examples of the carbon material include graphite, acetylene black, carbon nanotube, carbon fiber, and mesoporous carbon.

The binder is appropriately selected depending on the intended purpose without any limitation, and examples of the binder include: a fluorine-based binder, such as polyvinylidene fluoride (PVDF) and polytetrafluoroethylene (PTFE); ethylene-propylene-butadiene rubber (EPBR); styrene-butadiene rubber (SBR); and carboxy methyl cellulose (CMC). These may be used alone, or in combination. Among them, particularly preferred are the fluorine-based binder, such as polyvinylidene fluoride (PVDF), and polytetrafluoroethylene (PTFE).

### —Anode Current Collector—

The anode current collector is configured to collect power of the anode layer. A material of the anode current collector is appropriately selected depending on the intended purpose without any limitation, provided that the material has electric conductivity, and examples of the material of the anode current collector include copper, stainless steel, and nickel. Examples of a shape of the anode current collector include a foil, a plate, and a mesh (grid).

### —Formation Method of Anode—

The formation method of the anode is appropriately selected depending on the intended purpose without any limitation, provided that the formation method of the anode is a method capable of forming the aforementioned anode. Examples of the formation method of the anode include a method containing preparing a composition for forming an anode layer, which contains the anode active material, and a binder, applying the composition onto the anode current collector, and drying. As for another method for forming the anode, examples include a method containing providing the anode active material in the form of a foil onto the anode current collector, and pressing.

### <Cathode>

The cathode is an electrode, which is provided at the opposite side to the anode across the anion exchange membrane, and is in contact with air.

The cathode contains an amphoteric catalyst layer containing an amphoteric catalyst, and an oxygen reduction catalyst layer containing an oxygen reduction catalyst in this order from the side of the anion exchange membrane, where the amphoteric catalyst exhibits activity in oxygen reduction, and activity in oxygen generation, and the oxygen reduction catalyst exhibits in oxygen reduction. When the cathode contains the oxygen reduction catalyst layer, and the amphoteric catalyst layer in this order from the side of the anion exchange membrane, the capacity may largely reduce due to the discharge-charge cycle. This is because of the following reason. When platinum is used as the oxygen reduction catalyst layer, for example, the platinum is made in contact with the anion exchange membrane and the oxygen reduction catalyst layer formed of the platinum is deteriorated at the time of charging, to thereby lower the performance of the cathode.

As the amphoteric catalyst layer and the oxygen reduction catalyst layer are formed in this order from the side of the anion exchange membrane, an interface between the amphoteric catalyst layer and the oxygen reduction catalyst layer can be detected, for example, by exposing a cross-section of a sample, and observing the cross-section under a scanning electron microscope.

The amphoteric catalyst layer and the oxygen reduction catalyst layer may not be in contact with each other as long as the amphoteric catalyst layer and the oxygen reduction catalyst layer are formed in this order from the side of the anion exchange membrane, and another layer may be provided between the amphoteric catalyst layer and the oxygen reduction catalyst layer. However, it is preferred that the amphoteric catalyst layer and the oxygen reduction catalyst layer be adhered to each other.

### <<Amphoteric Catalyst Layer>>

The amphoteric catalyst layer is a layer containing an amphoteric catalyst that exhibits activity in oxygen reduction and activity in oxygen reduction.

The amphoteric catalyst layer contains an amphoteric catalyst, and a binder, and may further contain other components, if necessary.

### —Amphoteric Catalyst—

The amphoteric catalyst is appropriately selected depending on the intended purpose without any limitation, provided that the amphoteric catalyst is metal oxide exhibiting activity in oxygen redaction and activity in oxygen generation, and examples thereof include pyrochlore-structured metal oxide, perovskite-structured metal oxide, and spinel-structured metal oxide. Among them, the pyrochlore structured metal oxide is particularly preferable in view of excellent discharge output.

The pyrochlore structured metal oxide is transition metal oxide having the general composition formula: A₂B₂O₇, and preferably metal oxide represented by the following composition formula 1.

A₂[B₂₋ₓAₓ]O_{7-y} Composition Formula 1

In the composition formula 1, A denotes Pb or Bi; B denotes Ru or Ir; x satisfies 0≦x≦1; and y satisfies 0≦y≦0.5.

Among them, particularly preferred in view of excellent discharge output are Pb₂Ru₂O_{6.5}, Bi₂Ru₂O₇, or Pb₂Ir₂O_{6.5}, or any combination thereof.

The binder is appropriately selected depending on the intended purpose without any limitation, and examples of the binder include: an anion exchange resin having the same or similar performance to that of the anion exchange membrane; a fluorine-based binder, such as polyvinylidene fluoride (PVDF), and polytetrafluoroethylene (PTFE); ethylene-propylene-butadiene rubber (EPBR); styrene-butadiene rubber (SBR); and carboxymethyl cellulose (CMC). These may be used alone, or in combination. Among them the anion exchange resin having the same or similar performance to that of the anion exchange membrane is particularly preferable.

As for the anion exchange resin having the same or similar performance to that of the anion exchange membrane, an appropriately synthesized resin may be used, or a commercial product thereof may be used. Examples of the commercial product thereof include an anion-conducting electrolyte solution A-Solution, manufactured by Tokuyama Corporation.

A blending mass ratio (amphoteric catalyst/binder) of the amphoteric catalyst to the binder is appropriately selected depending on the intended purpose without any limitation, but the blending mass ratio is preferably 1/9 to 9/1.

Examples of the aforementioned other components include a solvent, and a dispersing agent. The solvent is appropriately selected depending on the intended purpose without any limitation, and examples of the solvent include water, and alcohol.

Examples of the formation of the amphoteric catalyst layer include a method containing preparing a composition for forming an amphoteric catalyst, which contains the amphoteric catalyst, and the binder, applying the composition onto the anion exchange membrane, and drying.

The average thickness of the amphoteric catalyst layer is preferably 5 μm to 25 μm, more preferably 10 μm to 20 μm. When the average thickness thereof is less than 5 μm, the amphoteric catalyst layer does not function as a protective layer of the oxygen reduction catalyst layer, and therefore a charging reaction is caused in the oxygen reduction catalyst layer at the time of charging, which may cause deterioration of the oxygen reduction catalyst layer. When the average thickness thereof is greater than 25 μm, the amphoteric catalyst layer becomes thick, and hence a path for supplying OH⁻ ions to the oxygen reduction catalyst layer becomes long. As a result, a supply amount of OH⁻ ions to the oxygen reduction catalyst layer is reduced to thereby delay an oxygen reduction reaction in the oxygen reduction catalyst layer, which may lower the discharge output of the air secondary battery.

### <<Oxygen Reduction Catalyst Layer>>

The oxygen reduction catalyst layer is a layer exhibiting activity in oxygen reduction, and contains an oxygen reduction catalyst, and a binder, and may further contain other components, if necessary.

### —Oxygen Reduction Catalyst—

The oxygen reduction catalyst is appropriately selected depending on the intended purpose without any limitation, and examples of the oxygen reduction catalyst include platinum, platinum alloy, and a catalyst bearing material in which an electroconductive power (e.g. carbon) bears platinum or platinum alloy thereon.

Examples of the platinum alloy include Pt—Co, Pt—Fe, and Pt—Ni.

### —Binder—

The binder is appropriately selected depending on the intended purpose without any limitation, and examples of the binder include: an anion exchange resin having the same or similar performance to that of the anion exchange membrane; a fluorine-based binder, such as polyvinylidene fluoride (PVDF), and polytetrafluoroethylene (PTFE); ethylene-propylene-butadiene rubber (EPBR); styrene-butadiene rubber (SBR); and carboxymethyl cellulose (CMC). These may be used alone, or in combination. Among them the anion exchange resin having the same or similar performance to that of the anion exchange membrane is particularly preferable.

As for the anion exchange resin having the same or similar performance to that of the anion exchange membrane, an appropriately synthesized resin may be used, or a commercial product thereof may be used. Examples of the commercial product thereof include an anion-conducting electrolyte solution A-Solution, manufactured by Tokuyama Corporation.

A blending mass ratio (oxygen reduction catalyst/binder) of the oxygen reduction catalyst to the binder is appropriately selected depending on the intended purpose without any limitation, but the ratio is preferably 1/9 to 9/1.

Examples of the aforementioned other components include a solvent, and a dispersing agent. The solvent is appropriately selected depending on the intended purpose without any limitation, and examples of the solvent include water, and alcohol.

Examples of the formation of the oxygen reduction catalyst layer include a method containing preparing a composition for forming an oxygen reduction catalyst layer, which contains the oxygen reduction catalyst and the binder, applying the composition onto the amphoteric catalyst layer formed on the anion exchange membrane, and drying.

The average thickness of the oxygen reduction catalyst layer is preferably 5 μm to 25 μm, more preferably 10 μm to 20 μm. When the average thickness is less than 5 μm, an amount of the oxygen reduction catalyst is reduced, and therefore an oxygen reduction reaction in the oxygen reduction catalyst layer is reduced, which may lower the discharge output of the air secondary battery. When the average thickness of the oxygen reduction catalyst layer is greater than 25 μm, the oxygen reduction catalyst layer becomes thick, and therefore a path for discharging oxygen gas generated in the amphoteric catalyst layer at the time of charging becomes long. As a result, oxygen discharge is retarded, which may lower charging performance of the air secondary battery.

The average total thickness of the amphoteric catalyst layer and the oxygen reduction catalyst layer is preferably 50 μm or less, more preferably 10 μm to 50 μm, and even more preferably 20 μm to 40 μm. When the average total thickness thereof is greater than 50 μm, the discharge output of the air secondary battery may be lowered, or oxygen discharge is retarded, which may lower charging performance of the air secondary battery.

A ratio (A/B) of the average thickness of the amphoteric catalyst layer (A), and the average thickness of the oxygen reduction catalyst layer (B) is preferably 1/5 to 5/1. When the ratio (A/B) is within the aforementioned numeral range, the resulting air secondary battery can discharge and charge with excellent repeating efficiency, and can realize excellent discharge output.

### —Electrolytic Solution—

As for the electrolytic solution, in the case where the anode is zinc or alloy thereof, an alkali aqueous solution (e.g., potassium hydroxide aqueous solution and sodium hydroxide aqueous solution) containing zinc oxide may be used, or an aqueous solution containing zinc chloride or zinc perchlorate may be used, or a nonaqueous solvent containing zinc perchlorate or a nonaqueous solvent containing zinc bis(trifluoromethylsulfonyl)imide may be used.

Examples of the nonaqueous solvent include organic solvents used conventional secondary batteries or capacitors, such as ethylene carbonate (EC), propylene carbonate (PC), γ-butyrolactone (γ-BL), diethyl carbonate (DEC), and dimethyl carbonate (DMC). Alternatively, an ionic liquid, such as N,N-diethyl-N-methyl-N-(2-methoxyethyl)ammonium bis(trifluoromethylsulfonyl)imide (am), may be used. These may be used alone, or in combination.

### —Cathode Case—

The cathode case contains a metal member, in which through holes, through which air comes in and out (may referred to as “air holes” hereinafter) are formed, and may further contain other members, if necessary. The cathode case also functions as a cathode terminal.

A material, shape, size and structure of the metal member are appropriately selected depending on the intended purpose without any limitation, provided that the metal member is a metal member, in which through holes for letting the air in and out are formed.

Examples of a material of the metal member include metal, in which nickel is plated on copper, stainless steel, stainless steel or iron.

Examples of a shape of the metal member include a shallow dish a rim of which is curled, a cylinder with a bottom base, and a square tube with a bottom base.

A size of the metal member is appropriately selected depending on the intended purpose without any limitation, provided that the metal member can be used for the air secondary battery.

A structure of the metal member may be a single-layer structure, or a laminate structure. Examples of the laminate structure include a three-layer structure containing nickel, stainless steel, and copper.

The metal member typically contains the through holes in the bottom part thereof. The number of the through holes may be on, or plural. A shape of the opening of the through hole is appropriately selected depending on the intended purpose without any limitation, and examples thereof include a circle, oval, square, rectangle, and lozenge. A size of the opening of the through hole is appropriately selected depending on the intended purpose without any limitation.

A production method of the through holes in the metal member is appropriately selected depending on the intended purpose without any limitation, and examples thereof include: a method containing punching the metal member with a metal mold to produce through holes; and a method weaving metal wires into a network to thereby produce a metal member of the predetermined shape and through holes at the same time.

### —Anode Case—

A material, shape, size and structure of the anode case are appropriately selected depending on the intended purpose without any limitation.

Examples of the material of the anode case include a metal, in which nickel is plated on copper, stainless steel, stainless steel, or iron.

Examples of a shape of the anode case include a shallow dish a rim of which is curled, a cylinder with a bottom base, and a square tube with a bottom base.

The size of the anode case is appropriately selected depending on the intended purpose without any limitation, provided that it is a size that can be used for the air secondary battery.

The structure of the anode case may be a single layer structure, or a laminate structure. Examples of the laminate structure include a three layer structure containing nickel, stainless steel, and copper.

### —Spacer—

A material, shape, size and structure of the spacer are appropriately selected depending on the intended purpose without any limitation.

Examples of the material of the spacer include: paper, such as kraft paper, vinylon mixed paper, synthetic pulp mixed paper; cellophane; a polyethylene grafted film; a polyolefin nonwoven fabric, such as polypropylene melt-blow nonwoven fabric; a polyamide nonwoven fabric; and glass fiber nonwoven fabric. These may be used alone, or in combination as a complex.

Examples of the shape of the spacer include a sheet shape.

The size of the spacer is appropriately selected depending on the intended purpose without any limitation, provided that the spacer can be used for the air secondary battery.

The structure of the spacer may be a single layer structure, or a laminate structure.

### —Gasket—

The gasket is appropriately selected depending on the intended purpose without any limitation, provided that the gasket is a material capable of maintaining insulation between the cathode case and the anode case. Examples of the gasket include: a polyester resin, such as polyethylene terephthalate; a fluororesin, such as polytetrafluoroethylene; a polyphenylene sulfide resin; a polyether imide resin; and a polyamide resin. These may be used alone, or in combination.

An embodiment of the disclosed air secondary battery is explained with reference to drawings.

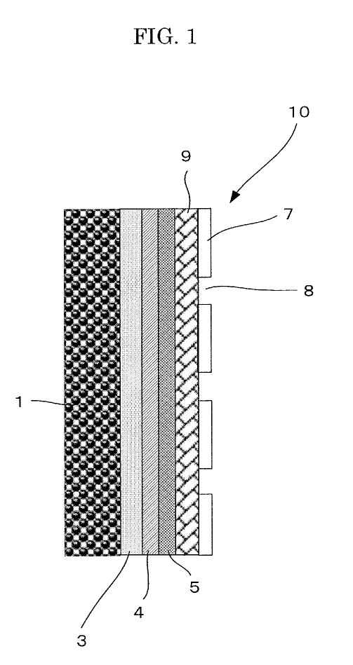

FIG. 1 is a schematic cross-sectional diagram illustrating one example of the disclosed air secondary battery. The metal-air secondary battery 10 of FIG. 1 contains, from the side of the cathode, a cathode case 7 in which air holes 8 are formed, a gaseous diffusion layer 9, an oxygen reduction catalyst layer 5, an amphoteric catalyst layer 4, an anion exchange membrane 3, and a metal anode 1.

The anion exchange membrane 3 is a polymer material that exhibits OH⁻ conductivity as impregnated with water, and is used as an OH⁻ conductive solid polymer electrolyte. Examples thereof include anion-conducting electrolyte membrane A series, manufactured by Tokuyama Corporation.

The amphoteric catalyst layer 4 has both an oxygen reduction ability, which generates OH⁻ through an electrochemical reaction between oxygen in the air and water in the electrolytic solution at the time of discharging, and an oxygen generation ability, which generate oxygen and water from OH⁻ through an electrochemical reaction at the time of charging. The amphoteric catalyst layer 4 has particularly excellent oxygen generation ability, and formed of a mixture containing an amphoteric catalyst having electron conductivity, and an anion exchange resin having the same or similar performance to that of the anion exchange membrane.

As for the amphoteric catalyst, for example, various types of electroconductive metal oxide can be used, but pyrochlore structured metal oxide, such as Pb₂Ru₂O_{6.5}, Bi₂Ru₂O₇, and Pb₂Ir₂O_{6.5}, is particularly suitable.

The amphoteric catalyst layer 4 can be formed by applying, onto the anionic exchange membrane 3, a composition prepared by mixing the anion exchange resin with the amphoteric catalyst.

The oxygen reduction catalyst layer 5 has excellent oxygen reduction ability, which generates OH⁻ from oxygen in the air and water in the electrolytic solution through an electrochemical reaction at the time of discharging, and is formed of a mixture containing a catalyst having electron conductivity, and an anion exchange resin having the same or similar performance to that of the anion exchange membrane. Examples of the oxygen reduction catalyst include platinum, and platinum alloy.

The oxygen reduction catalyst layer 5 can be formed by applying a composition, which is prepared by mixing the anion exchange resin with the oxygen reduction catalyst, onto the amphoteric catalyst layer formed on the anion exchange membrane 3.

The amphoteric catalyst layer 4 and the oxygen reduction catalyst layer 5 are formed in this order from the side of the anion exchange membrane, and form a layer structure having the average total thickness of 50 μm or less.

The metal anode 1 is formed from a mixture containing Zn powder, and an alkali electrolytic solution containing OH⁻. As for the alkali electrolytic solution, for example, a KOH aqueous solution, or NaOH aqueous solution can be used.

The gaseous diffusion layer 9 has a porous shape so that oxygen in the air can be introduced to the oxygen reduction catalyst layer 5 and the amphoteric catalyst layer 4, and desirably has electric conductivity, when the gaseous diffusion layer 9 is provided between the catalyst layer and the current collector. Examples of a material of the gaseous diffusion layer include carbon paper, manufactured by Toray Industries, Inc.

The functions of the disclosed air secondary battery are considered as follows.

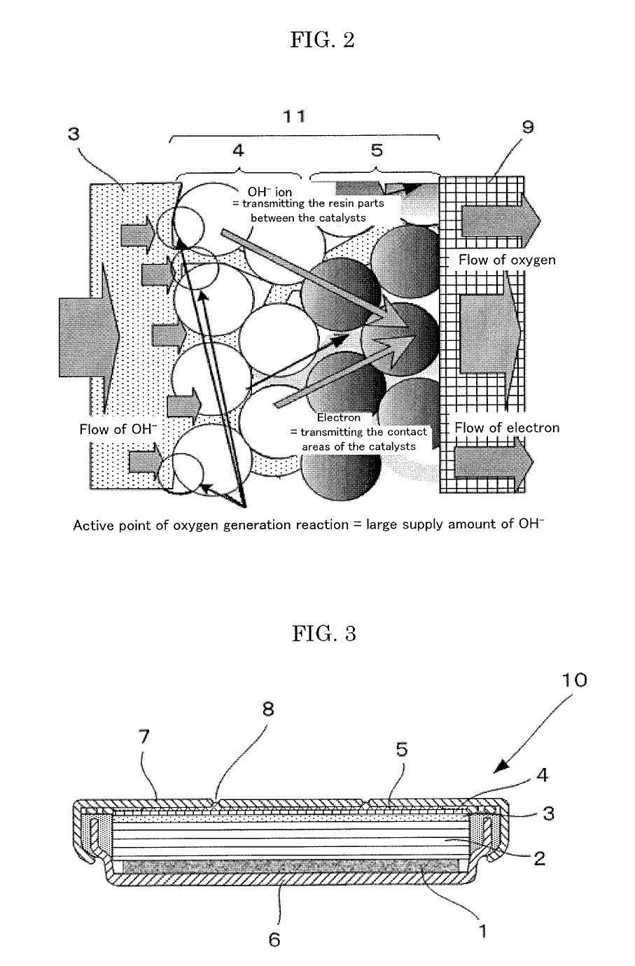

FIG. 2 depicts a cathode reaction model of the disclosed air secondary battery at the time of charging. The cathode catalyst layer 11 contains, from the side of the anion exchange membrane 3, an amphoteric catalyst layer 4 containing amphoteric catalyst particles, an oxygen reduction catalyst layer 5 containing oxygen reduction catalyst particles, and a gaseous diffusion layer 9 in this order. As the anion exchange resin and voids are present in the space created by each of these catalyst particles, a three-phase interface including a catalyst surface, electrolyte, and air, is formed inside the cathode catalyst layer 11 so that the cathode catalyst layer 11 has a structure, which can realize excellent oxygen reduction reactions and oxygen generation reactions.

In the cathode catalyst layer 11, electrons are transmitted through contact areas between the catalyst particles, and OH⁻ is transmitted through the anion exchange resin portions provided in the spaces between the catalyst particles. When a charging reaction is carried out in the cathode catalyst layer 11, OH⁻ is supplied from the entire anion exchange membrane 3 to the cathode catalyst layer 11, and inside the cathode catalyst layer, OH⁻ is supplied to the catalyst at the side of the cathode through the anion exchange resin portions. As for the electric potential of the cathode at the time of charging, a reaction is proceeded with lower potential when sufficient OH⁻ is supplied to the charging current, and therefore the electric potential of the cathode can be made low by providing the amphoteric catalyst layer 4 having high oxygen generation ability adjacent to the anion exchange membrane 3 to which the largest amount of OH⁻ is supplied. In addition, the oxygen reduction catalyst layer 5, which tends to be deteriorated with high electric potential, can be stably used by providing the oxygen reduction catalyst layer 5 to the side of the gaseous diffusion layer 9 of the amphoteric catalyst layer 4. Furthermore, discharge of oxygen generated during charging can be easily carried out by forming the amphoteric catalyst layer 4, and the oxygen reduction catalyst layer 5 on the anion exchange membrane 3 in this order in the manner that the average total thickness of the amphoteric catalyst layer 4 and the oxygen reduction catalyst layer 5 becomes 50 μm or less.

### —Shape—

A shape of the disclosed air secondary battery is appropriately selected depending on the intended purpose without any limitation, and examples of the shape thereof include a coin air secondary battery, a button air secondary battery, a sheet air secondary battery, a laminate air secondary battery, a cylinder air secondary battery, a flat air secondary battery, and a square air secondary battery.

### —Use—

The disclosed air secondary battery can be discharged and charged with excellent repeating efficiency, and has excellent discharge output, and therefore can be widely used as batteries for mobile devices, such as mobile phones, and laptops, batteries for memory back-up, batteries for small electric devices, batteries for hearing aids, batteries for hybrid cars, batteries for electric bicycles, dispersed power sources for domestic use, dispersed power sources for industrial use, and batteries for storing electricity.

The disclosed air secondary battery can solve the various problems in the art, achieve the aforementioned object, and can provide an alkali metal-air secondary battery capable of discharging and charging with desirable repeating efficiency, and having excellent discharge output.

### EXAMPLES

Examples of the disclosed air secondary battery are explained hereinafter, but the disclosed air secondary battery are not limited to these examples.

### Example 1

### —Production of Air Secondary Battery—

A metal anode was formed of a paste prepared by mixing a metal, Zn, and a 7M KOH aqueous solution at a mass ratio of 66/34.

As for a spacer, a glass fiber nonwoven fabric impregnated with a 7M KOH aqueous solution was used.

As for an anion exchange membrane, an anion-conducting electrolyte membrane A series, manufactured by Tokuyama Corporation, and having a film thickness of 30 μm was used.

On the anion exchange membrane, a paste, which had been prepared by adding 94% by mass of Pb₂Ru₂O_{6.5} (manufactured by FUJITSU LIMITED) to an anion exchange resin ionomer (anion-conducting electrolyte solution A-Solution, manufactured by Tokuyama Corporation), was applied, and then dried, to thereby form an amphoteric catalyst layer having the average thickness of 10 μm.

Next, on the amphoteric catalyst layer, a paste, which had been prepared by adding 90% by mass of platinum (Pt, HiSPEC™ 1000, manufactured by Alfa Aesar) to an anion exchange resin ionomer (anion-conducting electrolyte solution A-Solution, manufactured by Tokuyama Corporation) was applied, and the dried, to thereby form an oxygen reduction catalyst layer having the average thickness of 10 μm.

Using these materials, the anion exchange membrane 3, on which the metal anode 1, the KOH aqueous solution-impregnating spacer 2, the amphoteric catalyst layer (Pb₂Ru₂O_{6.5})4, and the oxygen reduction catalyst layer (Pt) 5 were formed in this order, was provided, to thereby produce air secondary battery 10 of Example 1, as illustrated in FIG. 3. Note that, in FIG. 3, 6 denotes an anode case, and 7 denotes a cathode case having air holes 8.

### Comparative Example 1

### —Production of Air Secondary Battery—

An air secondary battery of Comparative Example 1 was produced in the same manner as in Example 1, provided that the anion exchange membrane, on which the amphoteric catalyst layer (Pb₂Ru₂O_{6.5}) and the oxygen reduction catalyst layer (Pt) were formed in this order, was replaced with an anion exchange membrane, on which an oxygen reduction catalyst layer (Pt) having the average thickness of 10 μm and an amphoteric catalyst layer (Pb₂Ru₂O_{6.5}) having the average thickness of 10 μm were formed in this order.

### Comparative Example 2

### —Production of Air Secondary Battery—

An air secondary battery of Comparative Example 2 was produced in the same manner as in Example 1, provided that the anion exchange membrane, on which the amphoteric catalyst layer (Pb₂Ru₂O_{6.5}) and the oxygen reduction catalyst layer (Pt) were formed in this order, was replaced with an anion exchange membrane, on which an oxygen reduction catalyst layer (Pt) having the average thickness of 20 μm.

### Comparative Example 3

### —Production of Air Secondary Battery—

An air secondary battery of Comparative Example 3 was produced in the same manner as in Example 1, provided that the anion exchange membrane, on which the amphoteric catalyst layer (Pb₂Ru₂O_{6.5}) and the oxygen reduction catalyst layer (Pt) were formed in this order, was replaced with an anion exchange membrane, on which an amphoteric catalyst layer (Pb₂Ru₂O_{6.5}) having the average thickness of 20 μm.

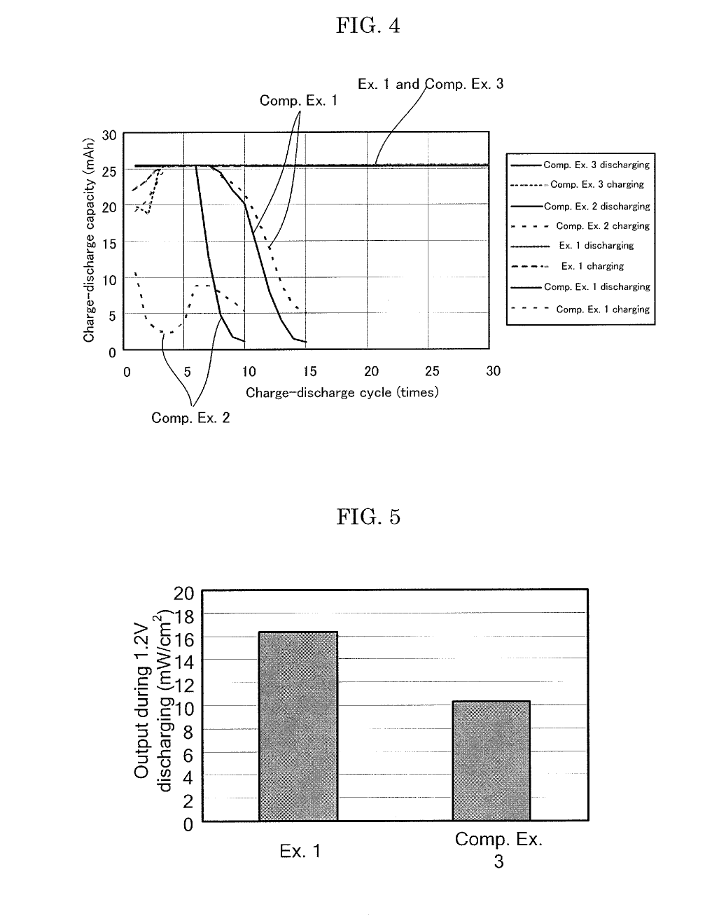

The produced air secondary batteries of Example 1 and Comparative Examples 1 to 3 were subjected to a discharge-charge cycle test, in which discharging was performed with constant electric current of 5 mA/cm², and regulated capacity of 25.4 mAh, and charging was performed with constant electric current of 5 mA/cm² and cut off at 2.0 V, in the following manner. A change in the battery capacity of each battery is depicted in FIG. 4.

It was found from the results depicted in FIG. 4 that the air secondary batteries of Example 1 and Comparative Example 3, each having the structure where the amphoteric catalyst, Pb₂R₂O_{6.5} was in contact with the anion exchange membrane maintained the excellent discharge-charge capacities after 30 cycles, whereas the air secondary batteries of Comparative Examples 1 and 2 each having a structure where the platinum (Pt) was in contact with anion exchange membrane had a large loss in the capacity due to the discharge-charge cycle. It was considered that the performance of the cathode in each of the air secondary batteries of Comparative Examples 1 and 2 was lowered, as the oxygen reduction catalyst layer formed of the platinum was deteriorated during the charging.

### <Measuring Method of Discharge-Charge Capacity in Discharge-Charge Cycle Test>

The discharge-charge cycle test was performed using a coin cell as illustrated in FIG. 3. The structure of the coin cell was as follows.

Cathode catalyst layer: circle with diameter of 18 mm, electrode area of 2.54 cm²
Anode: housing 1 g of a mixture containing Zn powder and a 7M KOH aqueous solution at a mass ratio of 66/34, i.e., charged electricity quantity of the anode being 546 mAh

A discharge-charge cycle test was performed on the coin cell starting from discharging under the following conditions.

Discharge: 5 mA/cm² to cathode catalyst layer=constant current discharging at the cell discharging current of 12.7 mA

The discharge was ended when the cell voltage became 0.6 V or lower, or after 2 hours (discharge capacity after discharging for 2 hours=25.4 mAh, about 5% of the charged electricity quantity of the anode was used).

Charging: 2.5 mA/cm² to the cathode catalyst layer=constant current charging at the cell charging current of 6.35 mA

The charging was ended when the cell voltage became 2.0 V or higher, or after 4 hours (charge capacity after charging for 4 hours=25.4 mAh)

The discharge and charge capacities determined in this test are represented as follows

Discharge capacity Qd (mAh)=12.7 (mA)×duration for discharging (h), 25.4 mAh max (ended in 2 hours at longest)

Charging capacity Qc (mAh)=6.35 (mA)×duration for charging (h), 25.4 mAh max (ended in 4 hours at longest)

Next, the air secondary batteries of Example 1 and Comparative Example 3, which exhibited excellent properties in the discharge-charge cycle test, were subjected to the measurement of the power density when operated at the cell voltage of 1.2 V, in the following manner. The results are depicted in FIG. 5. It was found from the results of FIG. 5 that the air secondary battery of Example 1 had the output about 1.5 times greater than that of Comparative Example 3, the air secondary battery having the cathode based on the disclosed technology had high performance.

### <Measuring Method of Power Density>

As for the measurement of the power density, a coin cell, which was the same as in the discharge-charge cycle test, was separately prepared, and cell voltage (V) x discharging current (mA) was calculated after constant voltage discharging was performed for 10 minutes at the cell voltage of 1.2 V.

In addition, air secondary batteries were prepared in the same manner as in Example 1, provided that the platinum (Pt) in the oxygen reduction catalyst layer was changed to platinum alloys (Pt—Co, Pt—Fe, and Pt—Ni), respectively.

Each of the produced air secondary batteries was subjected to the discharge-charge cycle test and the measurement of the power density in the same manner as in Example 1. As a result, it was confirmed that all the air secondary batteries exhibited excellent properties.

### Example 2

### —Production of Air Secondary Battery—

An air secondary battery of Example 2 was produced in the same manner as in Example 1, provided that the anion exchange membrane, on which the amphoteric catalyst layer (Pb₂Ru₂O_{6.5}) and the oxygen reduction catalyst layer (Pt) were formed in this order, was replaced with an anion exchange membrane, on which an amphoteric catalyst layer (Bi₂Ru₂O₇; manufactured by FUJITSU LIMITED) having the average thickness of 10 μm and an oxygen reduction catalyst layer (Pt) having the average thickness of 10 μm were formed in this order.

### Comparative Example 4

—Production of Air Secondary Battery—

An air secondary battery of Comparative Example 4 was produced in the same manner as in Example 1, provided that the anion exchange membrane, on which the amphoteric catalyst layer (Pb₂Ru₂O_{6.5}) and the oxygen reduction catalyst layer (Pt) were formed in this order, was replaced with an anion exchange membrane, an amphoteric catalyst layer (Bi₂Ru₂O₇) having the average thickness of 20μ was formed.

### <Discharge-Charge Capacity in Discharge-Charge Cycle Test, and Measuring Method of Power Density>

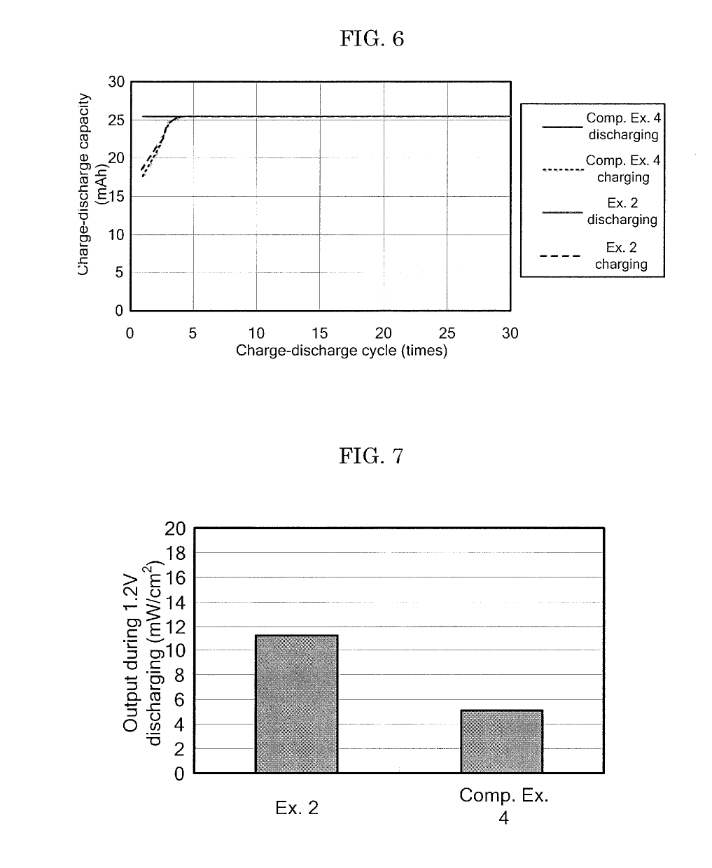

In the same manner as in Example 1 and Comparative Examples 1 to 2, a discharge-charge cycle test was performed on the produced air secondary batteries of Example 2 and Comparative Example 4. The results are depicted in FIG. 6. Moreover, the power density when operated at 1.2 V was measured in the same manner as in Example 1 and Comparative Example 3. The results are depicted in FIG. 7.

It was found from the results of FIG. 6 that the air secondary batteries of Example 2 and Comparative Example 4 had excellent discharge-charge capacities, similar to those of Example 1 and Comparative Example 3.

It was found from the results of FIG. 7 that the air secondary battery of Comparative Example 4 using the single material had the power density as operated at 1.2 V, which was about ½ of the power density of Comparative Example 3, but the air secondary battery of Example 2 attained the effect of improving the output that the power density thereof was about 2 times or more greater than that of Comparative Example 4. The reason thereof is considered that the effect of improving the output is reduced due to the Pt layer, when the catalyst layer having high output as used in Example 2 is replaced with the Pt layer.

### Example 3

### —Production of Air Secondary Battery—

An air secondary battery of Example 3 was produced in the same manner as in Example 1, provided that the anion exchange membrane, on which the amphoteric catalyst layer (Pb₂Ru₂O_{6.5}) and the oxygen reduction catalyst layer (Pt) were formed in this order, was replaced with an anion exchange membrane, on which an amphoteric catalyst layer (Pb₂Ir₂O_{6.5}; manufactured by KOJUNDO CHEMICAL LABORATORY CO., LTD.) having the average thickness of 10 μm and an oxygen reduction catalyst layer (Pt) having the average thickness of 10 μm were formed in this order.

### Comparative Example 5

—Production of Air Secondary Battery—

An air secondary battery of Comparative Example 5 was produced in the same manner as in Example 1, provided that the anion exchange membrane, on which the amphoteric catalyst layer (Pb₂Ru₂O_{6.5}) and the oxygen reduction catalyst layer (Pt) were formed in this order, was replaced with an anion exchange membrane, on which an amphoteric catalyst layer (Pb₂Ir₂O_{6.5}) having the average thickness of 20 μm was formed.

### <Discharge-Charge Capacity in Discharge-Charge Cycle Test, and Measuring Method of Power Density>

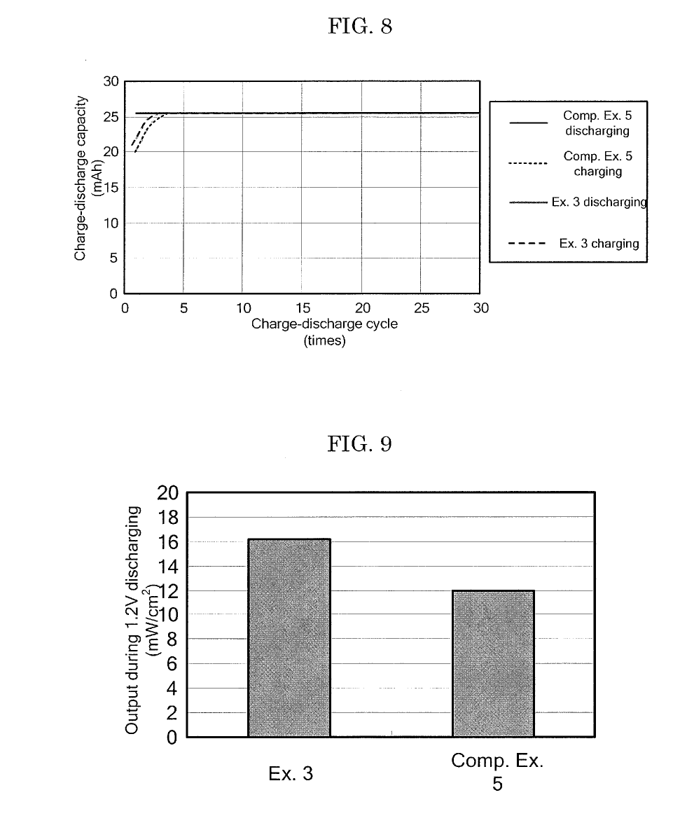

In the same manner as in Example 1 and Comparative Examples 1 to 2, a discharge-charge cycle test was performed on the produced air secondary batteries of Example 3 and Comparative Example 5. The results are depicted in FIG. 8. Moreover, the power density when operated at 1.2 V was measured in the same manner as in Example 1 and Comparative Example 3. The results are depicted in FIG. 9.

It was found from the results of FIG. 8 that the air secondary batteries of Example 3 and Comparative Example 5 had excellent discharge-charge capacities, similar to those of Examples 1 to 2 and Comparative Examples 3 to 4.

It was found from the results of FIG. 9 that the air secondary battery of Comparative Example 5 using the single material exhibited excellent properties that the power density thereof as operated at 1.2 V was improved by 20% compared to that of Comparative Example 3, but the air secondary battery of Example 3 attained the effect of improving the output that the power density thereof was about 1.3 times greater than that of Comparative Example 5. The reason thereof is considered that the effect of improving the output is reduced due to the Pt layer, when the catalyst layer having high output as used in Example 3 is replaced with the Pt layer.

### Referential Example 1

### —Production of Air Secondary Battery—

An air secondary battery of Referential Example 1 was produced in the same manner as in Example 1, provided that the anion exchange membrane, on which the amphoteric catalyst layer (Pb₂Ru₂O_{6.5}) and the oxygen reduction catalyst layer (Pt) were formed in this order, was replaced with an anion exchange membrane, on which an amphoteric catalyst layer (LaCoO₃; perovskite structure metal oxide) having the average thickness of 20 μm was formed.

### Referential Example 2

### —Production of Air Secondary Battery—

An air secondary battery of Referential Example 2 was produced in the same manner as in Example 1, provided that the anion exchange membrane, on which the amphoteric catalyst layer (Pb₂Ru₂O_{6.5}) and the oxygen reduction catalyst layer (Pt) were formed in this order, was replaced with an anion exchange membrane, on which an amphoteric catalyst layer (La_{0.5}Sr_{0.5}CoOₓ; perovskite-structure metal oxide) having the average thickness of 20 μm was formed.

### Referential Example 3

### —Production of Air Secondary Battery—

An air secondary battery of Comparative Example 3 was produced in the same manner as in Example 1, provided that the anion exchange membrane, on which the amphoteric catalyst layer (Pb₂Ru₂O_{6.5}) and the oxygen reduction catalyst layer (Pt) were formed in this order, was replaced with an anion exchange membrane, on which an amphoteric catalyst layer (Co₃O₄; spinel-structured metal oxide) having the average thickness of 20 μm was formed.

### <Measuring Method of Power Density>

The produced air secondary batteries of Referential Examples 1 to 3 were each subjected to the measurement of the power density in the same manner as in Example 1. As a result, discharging of the air secondary batteries of Referential Examples 1 to 3 could not be performed at 1.2 V, and the power density thereof as discharged at 0.8 V was extremely low, i.e., 0.1 mW/cm² or lower. The reason thereof is considered that an electrochemical reaction is difficult to proceed on the electrode, as the electron conductivity of the perovskite-structure metal oxide and that of spinel-structured metal oxide are significantly low compared to that of the pyrochlore structured metal oxide. Accordingly, the evaluation of the discharge-charge cycle properties was not performed on the air secondary batteries of Referential Examples 1 to 3.

The disclosed air secondary battery can be discharged and charged with excellent repeating efficiency, and has excellent discharge output, and therefore can be widely used as batteries for memory back-up, batteries for small electric devices, batteries for hearing aids, batteries for hybrid cars, batteries for electric bicycles, dispersed power sources for domestic use, dispersed power sources for industrial use, and batteries for storing electricity.

All examples and conditional language provided herein are intended for pedagogical purposes to aid the reader in understanding the invention and the concepts contributed by the inventor to further the art, and are not to be construed as limitations to such specifically recited examples and conditions, nor does the organization of such examples in the specification related to a showing of the superiority and inferiority of the invention. Although one or more embodiments of the present invention have been described in detail, it should be understood that the various changes, substitutions, and alterations could be made hereto without departing from the spirit and scope of the invention.

1. An air secondary battery, comprising:
an anion exchange membrane;
an anode containing a metal, which is provided at one side of the anion exchange membrane; and
a cathode, which is provided at the opposite side of the anode across the anion exchange membrane, and is in contact with air,
wherein the cathode contains an amphoteric catalyst layer containing an amphoteric catalyst, and an oxygen reduction catalyst layer containing an oxygen reduction catalyst in this order from the side of the anion exchange membrane, where the amphoteric catalyst exhibits activity in oxygen reduction, and activity in oxygen generation, and the oxygen reduction catalyst exhibits activity in oxygen reduction.

2. The air secondary battery according to claim 1, wherein the amphoteric catalyst is pyrochlore structured metal oxide.

3. The air secondary battery according to claim 2, wherein the pyrochlore structured metal oxide is represented by the following composition formula 1:
A₂[B₂₋ₓAₓ]O_{7-y} Composition Formula 1
where A denotes Pb or Bi; B denotes Ru or Ir; x satisfies 0≦x≦1; and y satisfies 0≦y≦0.5.

4. The air secondary battery according to claim 2, wherein the pyrochlore structured metal oxide is Pb₂Ru₂O_{6.5}, Bi₂Ru₂O₇, or Pb₂Ir₂O_{6.5}, or any combination thereof.

5. The air secondary battery according to claim 1, wherein the oxygen reduction catalyst is platinum, or platinum alloy, or any combination thereof.

6. The air secondary battery according to claim 1, wherein both the amphoteric catalyst layer and the oxygen reduction catalyst layer contain an anion exchange resin.

7. The air secondary battery according to claim 1, wherein a total average thickness of the amphoteric catalyst layer and the oxygen reduction catalyst layer is 50 μm or less.

8. The air secondary battery according to claim 1, wherein a ratio A/B is 1/5 to 5/1, where A is an average thickness of the amphoteric catalyst layer, and B is an average thickness of the oxygen reduction catalyst layer.

9. The air secondary battery according to claim 1, wherein the anion exchange membrane is OH⁻ conductive solid polymer electrolyte.

10. The air secondary battery according to claim 1, further comprising a gaseous diffusion layer, which is provided at the side of the cathode of the oxygen reduction catalyst layer.
